(19) United States
(12) Patent Application Publication
(10) Pub. No.: US 2023/0252499 A1
(43) Pub. Date: Aug. 10, 2023

(54) INFORMATION-GREEDY MULTI-ARM BANDITS FOR ELECTRONIC USER INTERFACE EXPERIENCE TESTING

(71) Applicant: Home Depot Product Authority, LLC, Atlanta, GA (US)

(72) Inventors: Ding Xiang, Atlanta, GA (US); Jiaqi Wang, Atlanta, GA (US); Rebecca West, Smyrna, GA (US); Xiquan Cui, Brookhaven, GA (US); Jinzhou Huang, Kennesaw, GA (US)

(21) Appl. No.: 17/887,195

(22) Filed: Aug. 12, 2022

Related U.S. Application Data
(60) Provisional application No. 63/308,700, filed on Feb. 10, 2022.

(51) Int. Cl. G06Q 30/02

(52) U.S. Cl. CPC G06Q 30/0201

(57) ABSTRACT

A method for determining a user experience for an electronic user interface includes defining a test period for testing two or more versions of an electronic user interface, receiving, from each of a plurality of users during the test period, a respective request for the electronic user interface, determining, for each of the plurality of users, a respective version of the two or more versions of the electronic user interface by maximizing test power during the test period while maintaining higher in-test rewards than an A/B test or maximizing the rewards during the test period while maintaining a test power no worse than an A/B test, and causing, for each of the plurality of users, the determined version of the electronic user interface to be delivered to the user.

### FIELD OF THE DISCLOSURE

The present disclosure generally relates to website experience testing, including multi-arm bandit methods for website experience testing.

### BRIEF DESCRIPTION OF THE DRAWINGS

FIG. 1 is a block diagram illustrating an example system for deploying a website experience testing algorithm.

FIG. 2 is a flow chart illustrating an example method of delivering a respective website experience to each of a plurality of users.

FIG. 3 is a table illustrating results of tests performed according to the novel approaches of this disclosure compared to known approaches.

FIG. 4 is a table illustrating results of tests performed according to the novel approaches of this disclosure compared to known approaches.

FIG. 5 is a plot illustrating results of tests performed according to the novel approaches of this disclosure compared to known approaches.

FIG. 6 is a plot illustrating results of tests performed according to the novel approaches of this disclosure compared to known approaches.

FIG. 7 is a series of bar graphs illustrating results of tests performed according to the novel approaches of this disclosure compared to known approaches.

FIG. 8 is a series of plots illustrating results of tests performed according to the novel approaches of this disclosure compared to known approaches.

FIG. 9 is a series of plots illustrating results of tests performed according to the novel approaches of this disclosure compared to known approaches.

FIG. 10 is a block diagram view of a user computing environment.

### DETAILED DESCRIPTION

Current approaches for testing different website experiences either do not appropriately maximize the power of the test, or do not maximize the rewards associated with the testing period. For example, A/B tests generally assign users to the experiences under test at random and with equal probability. As a result, a typical A/B test does not maximize the rewards of the testing period, particularly when one of the experiences under test clearly underperforms. In another example, a typical multi-arm bandit (MAB) approach may maximize in-test rewards, but has relatively low testing power because different experiences are tested in different quantities. An experience testing approach according to the present disclosure may maximize both test power and in-test rewards, improving upon both A/B testing and typical MAB approaches.

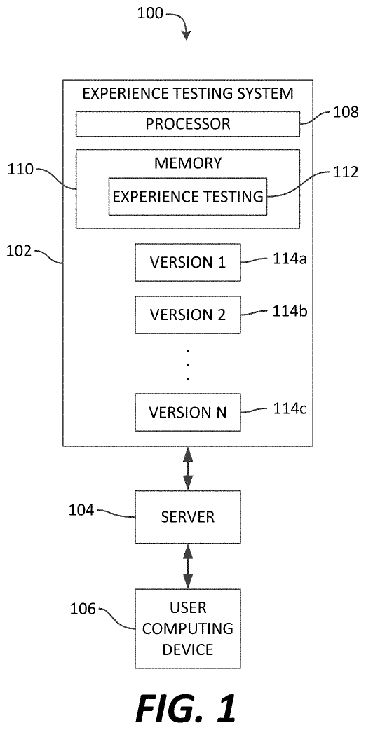

Referring to the drawings, wherein like numerals refer to the same or similar features in the various views, FIG. 1 is a block diagram illustrating an example system 100 for performing a an experience test for an electronic user interface, such as a website or a mobile device application, and deploying a most successful tested experience. The system 100 may include an experience testing system 102, a server 104, and a user computing device 106.

The experience testing system 102 may include a processor 108 and a non-transitory, computer readable memory 110 storing instructions that, when executed by the processor 108, cause the system 102 to perform one or more processes, methods, algorithms, steps, etc. of this disclosure. For example, the memory may include an experience testing module 112 configured to conduct a test of a plurality of website experiences.

The experience testing system 102 may be deployed in connection with an electronic user interface, such as a website or mobile application hosted by the server 104 for access by the user computing device 106 and/or a plurality of other user computing devices. The experience testing system may test different experiences on the interface to determine a preferred experience going forward. Experiences may include, for example, different layouts of the interface, different search engine parameter settings, different document recommendation strategies, and/or any other setting or configuration of the interface that may affect the user experience on the interface. For example, experiences may be represented in various versions 114a, 114b, 114c of a portion of the website or other electronic user interface (which may be referred to herein individually as a version 114 or collectively as the versions 114).

To conduct an experience test, the experience testing system 102 may cause the server 104 to provide one of the different experiences (e.g., one of versions 114a, 114b, 114c) to each of a plurality of different users according to a particular strategy. For example, in a traditional A/B test strategy, the server 104 would provide a randomly-selected one of the experiences to each user, with each experience having an equal probability of being provided by the server 104. Two particular novel approaches, which may be referred to as information-greedy MAB approaches, are described herein.

In a first example, an information-greedy multi-arm bandit may seek to maximize test power during the test period while maintaining higher in-test rewards than an A/B test. For example, in some embodiments, an information-greedy MAB deployed to test two experiences may calculate a ratio of the total number of times each experience has been provided to users, calculate a square root of a ratio of experience cumulative rewards, where the cumulative rewards for each experience are calculated as a product of the cumulative reward of the experience and one-minus that reward (where a reward is expressed as a zero or one), and compare the number of times ratio to the square root to determine the appropriate experience to serve.

In a second example, an information-reward-greedy MAB may also seek to maximize the rewards during the test period while maintaining a test power no worse than an AB test. For example, in some embodiments, an information-reward-greedy MAB deployed to test two experiences may calculate a ratio of the total number of times each experience has been provided to users, calculate a ratio of experience cumulative rewards, where the cumulative rewards for each experience are calculated as a product of the cumulative reward of the experience and one-minus that reward (where a reward is expressed as a zero or one), and compare the two ratios to determine the appropriate experience to serve.

The experience testing module 112 may conduct a test of the various versions 114 during a predefined test period in order to determine a preferred one of the versions 114. The predefined test period may be or may include a predefined number of test users, in some embodiments. Additionally or alternatively, the predefined test period may be or may include a time period. After the test period, the preferred version (e.g., version 114b) may be provided to users going forward.

Although experience testing is described herein as being performed by a backend system associated with a server, it should be understood that some or all aspects of an experience test may instead be performed locally (e.g., on one or more user computing devices 106). For example, the functionality of the experience testing system 102 may be implemented on a user computing device 106. For example, a user computing device 106 may have the versions 114 stored on the memory of the user computing device 106, and the user computing device 106 may determine rewards associated with a given instance of a particular version being selected, and may report that reward back to a backend system that performs version selection according to rewards determined by many user computing devices 106 according to their respective experiences.

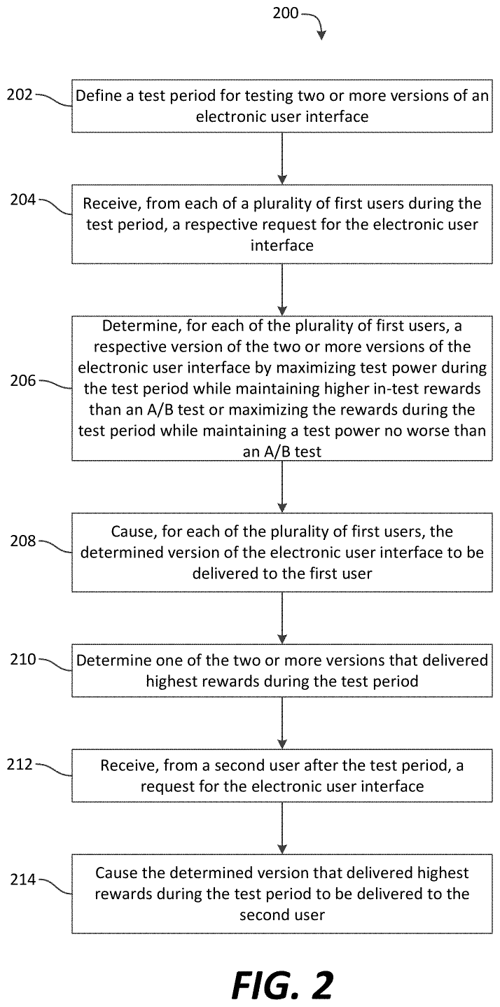

FIG. 2 is a flow chart illustrating an example method 200 of determining a user experience for an electronic user interface. The method 200, or one or more portions of the method 200, may be performed by the experience testing system 102, in some embodiments.

The method 200 may include, at block 202, defining a test period for testing two or more versions of an electronic user interface. The two or more versions may be or may include different user experiences on the electronic user interface. The electronic user interface may be or may include a website, a webpage, or a portion of a webpage, for example. The different user experiences may be or may include different search engine parameter settings, different document recommendation strategies, and/or any other setting or configuration of the interface that may affect the user experience on the interface. The test period may be defined to include a time period, a quantity of tested users, a quantity of tests of one or more of the versions (e.g., all versions), and/or some other parameter. Additionally or alternatively, the test period may be defined as a period necessary to determine a superior version of the interface by a minimum threshold, as discussed below.

In some embodiments, block 202 may additionally include defining the two or more versions. In some embodiments, the versions may be defined automatically (e.g., through algorithmic or randomized determination of a page configuration, algorithmic determination of a set of search engine parameter values, etc. In some embodiments, the versions may be defined manually.

The method 200 may further include, at block 204, receiving, from each of a plurality of first users during the test period, a respective request for the electronic user interface. Each user request may be, for example, a request for (e.g., attempt to navigate to) a portion of the electronic user interface that includes the relevant version. For example, where the difference between versions is different search engine parameter settings, requests received at block 204 may include search requests by the users. In another example, where the difference between versions is different layout for a home page of a website, requests received at block 204 may include user requests for the website domain through their browser.

The method may further include, at block 206, determining, for each of the plurality of first users, a respective version of the two or more versions of the electronic user interface. The determination at block 206 may include maximizing test power during the test period while maintaining higher in-test rewards than an A/B test or maximizing the rewards during the test period while maintaining a test power no worse than an A/B test. Both of these options are referred to herein as “information greedy MAB” approaches. These two approaches are discussed in turn below.

Before describing the information greedy MAB algorithms in detail, the general model formulation and notations for MAB algorithms is first described. Assume we have K competing versions or experiences (also known as “arms” of a MAB test), denoted by set E={1, 2, . . . , K}, and a decision strategy S such that for every customer's visit at time t, the strategy Scan decide which one of the experiences, eₜ∈E, to show. After showing the experience eₜ, we will see a feedback or reward, denoted by rₜ, from the user who received the experience. The feedback could either be Boolean or binary (rₜ∈{0, 1}) such as the experience being click or not, and a purchase being made or not, or continuous (rₜ∈R, rₜ≥0) such as the total price of the order, and the dwelling time on that experience etc. For this work, we focus on the binary feedback or reward, i.e., rₜ∈{0, 1} and rₜ=1 meaning positive feedback such as an effective purchase, click, etc., and rₜ=0 meaning negative feedback (or no feedback), such as by the user not performing any desired action after being delivered the selected interface version.

Assume the probability of getting a reward of 1 for showing an experience e∈E is p(e), and it is unchanged overtime. Assume users visit in a time sequence (t₁, t₂, t₃, . . . ) denoted by (tᵢ)ᵢ₌₁^{∞}, where t₁≤t₂≤t₃≤ . . . , which allows multiple visits at the same time. Also, the superscript ∞ can be replaced by a finite number if only a fixed time range is considered; this is also true for the sequences below). At each visit, a version is decided and delivered to a user by using strategy S. Then we have a logging of the delivered experiences and corresponding rewards, i.e., a sequence of experience-reward pairs ((eₜ_{₁}, rₜ_{₁}), (eₜ_{₂}, rₜ_{₂}), (eₜ_{₃}, rₜ_{₃}), . . . ), denoted by (eₜ_{₁}, rₜ_{₁})ᵢ₌₁^{∞}.

At any time tₙ, the performance of an experience e in E may be measured, using the logging generated by strategy S up to time tₙ, (eₜ_{₁}, rₜ_{₁})ᵢ₌₁ⁿ. Equation 1 below describes the total number of times Nₜ_{ₙ}(e) that a version e has been provided to users through time tₙ:

Nₜ_{ₙ}(e)=Σᵢ₌₁ⁿ [symbol] (e=eₜ_{ᵢ}), for e∈E (Eq. 1)

where [symbol] (·) is the indicator function. The collective total number n of times that all versions have been provided to users through time tₙ is shown in equation 2 below:

n=Σ_{e∈E}Nₜ_{ₙ}(e) (Eq. 2)

The total reward R for showing version e up to time tₙ is shown in equation 3 below:

Rₜ_{ₙ}(e)=Σᵢ₌₁ⁿrₜ_{ᵢ} [symbol] (e=eₜ_{ᵢ}), for e∈E (Eq. 3)

The average reward p for showing experience e up to time tₙ, is shown in equation 4 below:

$${p}_{{t}_{n}} ( e ) = \frac{{R}_{{t}_{n}} ( e )}{{N}_{{t}_{n}} ( e )} , for e ∈ E \qquad ( Eq . 4 )$$

e.g. the current conversion rate, and click through rate for each competing experience are described by this quantity. It should be noted that, if Nₜ_{ₙ}(e)=0, then set pₜ_{ₙ}(e) should be set to zero.

There are many strategies to decide which experience to show at each visit time. Depending on purposes, some of them may only use randomness. For example, the standard A/B test assigns an equal probability for each experience to show, until enough experience-reward samples are collected for conducting statistical analysis and selecting a best version. Multi armed bandit (MAB) algorithms, on the other hand, continue adjusting the strategy by balancing randomness (exploration) and current optimal choice (exploitation) based on the most recent performance, in order to achieve a higher overall average reward (including in-test rewards).

For A/B testing, the parameters needed before starting the sampling process include confidence level or type I error α; type II error β (or equivalently the power of the test 1−β), and effect size (unstandardized) d, also often referred to as minimum detectable effect (MDE). Then the minimal sample sizes needed to guarantee the above specifications may be computed. Using a known formulation for running z-test (or t-test when sample size larger than 30) of comparing two sample means, where the null hypothesis is H₀: d=0 and alternative hypothesis is H₁: d≠0 we can have the minimal sample sizes for the two groups, i.e., n₁ and n₂ shown in equations 5 and 6 below:

$${n}_{1} = λ {n}_{2} \qquad ( Eq . 5 )$$

$${n}_{2} = \frac{{( {z}_{α / 2} + {z}_{β} )}^{2}}{{d}^{2}} [ {p}_{1} ( 1 - {p}_{1} ) / λ + {p}_{2} ( 1 - {p}_{2} ) ] \qquad ( Eq . 6 )$$

where z_{α/2} is the (1−α/2)-th lower quantile of a standard normal distribution, and p₁ and p₂ are the true means of the two groups.

Since, in an A/B test, two groups have the same sample size, it can be assumed that λ=1 and obtain the minimal total sample size N according to equation 7 below:

$$N = \frac{2 {( {z}_{α / 2} + {z}_{β} )}^{2}}{{d}^{2}} [ {p}_{1} ( 1 - {p}_{1} ) + {p}_{2} ( 1 - {p}_{2} ) ] \qquad ( Eq . 7 )$$

MAB and A/B Test Theoretical Comparison. As noted above, A/B testing focuses on pair-wise comparisons using an equal (uniform) traffic split, but generally ignores a potentially high opportunity cost during the test (e.g., in-test rewards), while traditional MAB approaches focus on minimizing the opportunity cost (or identifying the best arm as quickly as possible), but oftentimes ends up with very unbalanced or arbitrary sample sizes over different competing experiences, thus makes the post pair-wise comparisons difficult to generate meaningful insights.

The instant application discloses two novel approaches to leverage the strengths of both MAB and A/B testing. The first one, referred to herein as “information-greedy MAB,” shown in detail in Algorithm 1 below, maximizes the power of the test by maintaining the user traffic split at the optimal split point. When the ground truth success rate for different experiences falls within the conditions set forth in equation 8, the MAB algorithm will also achieve higher or equal cumulative rewards than A/B test beside the optimal test power.

$$\frac{{N}_{{p}_{1}} ( 1 - {p}_{1} )}{{p}_{1} ( 1 - {p}_{1} ) + {p}_{2} ( 1 - {p}_{2} )} \leq {n}_{1} \leq \frac{N}{2} \qquad ( Eq . 8 )$$

Algorithm 1

| Parameters : T ∈ (0, +∞] | | |
|---|---|---|
| Initialization : pₜ_{ₙ} (e) = 0, ∀e ∈ E = {1, 2}; H₀ = {an empty | | |
| logging}; n = 0 | | |
| while tₙ₊₁ < T do | | |
| \| | 1. | |
| \| | if ∃ e ∈ E = {1, 2} s.t. Nₜ_{ₙ} (e) = 0 or | |
| \| | pₜ_{ₙ} (e) (1 − pₜ_{ₙ} (e)) = 0 then | |
| \| | \| | eₜ_{ₙ₊₁} = a random selected e ∈ {1, 2} |
| \| | else | |
| \| | \| | $if \frac{{N}_{{t}_{n}} ( 1 )}{{N}_{{t}_{n}} ( 2 )} < \sqrt{\frac{{p}_{{t}_{n}} ( 1 ) ( 1 - {p}_{{t}_{n}} ( 1 ) )}{{p}_{{t}_{n}} ( 2 ) ( 1 - {p}_{{t}_{n}} ( 2 ) )}} then {e}_{{t}_{n + 1}} = 1 ;$ |
| \| | \| | $else if \frac{{N}_{{t}_{n}} ( 1 )}{{N}_{{t}_{n}} ( 2 )} > \sqrt{\frac{{p}_{{t}_{n}} ( 1 ) ( 1 - {p}_{{t}_{n}} ( 1 ) )}{{p}_{{t}_{n}} ( 2 ) ( 1 - {p}_{{t}_{n}} ( 2 ) )}} then {e}_{{t}_{n + 1}} = 2 ;$ |
| \| | \| | else eₜ_{ₙ₊₁} = a random selected e ∈ {1, 2}; |

| | |
|---|---|
| \| | end |
| \| | 2. Observe rₜ_{ₙ₊₁}; Hₙ₊₁ = concatenate (Hₙ, (eₜ_{ₙ₊₁}, rₜ_{ₙ₊₁})) |
| \| | 3. n → n + 1 |

end

As shown in algorithm 1 above, an info-greedy MAB approach may include calculating a first ratio of the total number of times each of the two versions has been provided to users, calculating a square root of a second ratio of cumulative rewards of the two versions, where the cumulative rewards for each version are calculated as a product of the cumulative reward of the version and one-minus the cumulative reward of the version, and comparing the first ratio to the square root of the second ratio.

The second approach, referred to herein as “info-reward-greedy MAB”, is given in Algorithm 2 below. This second approach seeks to maximize the cumulative rewards under the constraint that its power is no less than AB test power, when the ground truth success rate for different experiences falls within the conditions set forth in equation 8 above.

Algorithm 2

| Parameters : T ∈ (0, +∞] | | | |
|---|---|---|---|
| Initialization : pₜ_{ₙ} (e) = 0, ∀e ∈ E = {1, 2}; H₀ = {an empty | | | |
| logging}; n = 0 | | | |
| while tₙ₊₁ < T do | | | |
| \| | 1. | | |
| \| | if ∃ e ∈ E = {1, 2} s.t. Nₜ_{ₙ} (e) = 0 or | | |
| \| | pₜ_{ₙ} (e) (1 − pₜ_{ₙ} (e)) = 0 then | | |
| \| | \| | eₜ_{ₙ₊₁} = a random selected e ∈ {1, 2} | |
| \| | else | | |
| \| | \| | $set λ = \frac{{N}_{{t}_{n}} ( 1 )}{{N}_{{t}_{n}} ( 2 )} and η = \frac{{p}_{{t}_{n}} ( 1 ) ( 1 - {p}_{{t}_{n}} ( 1 ) )}{{p}_{{t}_{n}} ( 2 ) ( 1 - {p}_{{t}_{n}} ( 2 ) )}$ | |
| \| | \| | if pₜ_{ₙ} (1) ≤ pₜ_{ₙ} (2) then | |
| \| | \| | \| | if λ < η then eₜ_{ₙ₊₁} = 1; |
| \| | \| | \| | else if λ > η then eₜ_{ₙ₊₁} = 2; |
| \| | \| | \| | else eₜ_{ₙ₊₁} = a random selected e ∈ {1, 2}; |
| \| | \| | else | |
| \| | \| | \| | if λ < η then eₜ_{ₙ₊₁} = 2; |
| \| | \| | \| | else if λ > η then eₜ_{ₙ₊₁} = 1; |
| \| | \| | \| | else eₜ_{ₙ₊₁} = a random selected e ∈{1, 2}; |

| | | |
|---|---|---|
| \| | \| | end |

| | |
|---|---|
| \| | end |
| \| | 2. Observe rₜ_{ₙ₊₁}; Hₙ₊₁ = concatenate (Hₙ, (eₜ_{ₙ₊₁}, rₜ_{ₙ₊₁})) |
| \| | 3. n → n + 1 |

end

As shown in algorithm 2 above, an info-reward-greedy MAB approach may include calculating a first ratio of the total number of times each version has been provided to users, calculating a second ratio of cumulative rewards for the two versions, where the cumulative rewards for each version are calculated as a product of the cumulative reward of the experience and one-minus that reward, and comparing the first ratio to the second ratio.

In some embodiments, either an info-greedy MAB or an info-reward-greedy MAB may be implemented to select respective interface versions for users during the test period at block 206.

The method 200 may further include, at block 208, for each of the plurality of first users, causing the determined version of the electronic user interface to be delivered to the first user. For example, where the determined version is a particular page layout, block 208 may include causing the particular page layout to be displayed for the user (e.g., by transmitting, or causing to be transmitted, the page and the particular layout to the user computing device from which the request was received). Where the determined version is a particular set of search engine parameters, in another example, block 208 may include causing search results obtained according to those particular parameters to be delivered to the user (e.g., displayed in the interface for the user).

Blocks 204, 206, and 208 may be performed for the duration of the test period. Where the test period is a defined time period or number of users or similar, the cumulative rewards of each version may be tracked throughout the test period to enable the comparisons at block 206. Where the test period terminates when one version demonstrates a predetermined degree of superiority over other tested versions, the cumulative rewards of each version may be tracked throughout the test period, and the cumulative or average per-user rewards of the different experiences may be compared to each other on a periodic basis (e.g., after every first user's reward). In some embodiments, when the cumulative or average rewards of a given version is greater than each other version by a predetermined threshold, the test period may be terminated.

The method 200 may further include, at block 210, determining one of the two or more versions that delivered highest rewards during the test period. In some embodiments, block 210 may include determining a respective reward quantity as to each user during the test period. As noted above, a reward may be a binary or Boolean value, or may be a value form a continuous range. A reward may be indicative of whether or not—or the degree to which—the user performed a predetermined desired action. The action may be, for example, a user click on or other selection of a particular portion of the interface, a user navigation to a particular portion of the interface, a user completing a transaction through the interface, a value of a transaction completed by the user through the interface, etc. In some embodiments, block 210 may include assigning a reward value to a particular user action. For example, for a Boolean action, assigning a value may include assigning a first value to the action being performed, and a second value to the action not being performed. For a reward value from a continuous range, assigning a value may include selecting a value from within the range based on the desirability of the user action, and/or scaling a value associated with the user action to a common scale for all rewarded actions (e.g., scaling all values to a continuous range between zero and one). Block 210 may include selecting a version that delivered highest cumulative rewards during the test period as the determined version, in some embodiments. Block 210 may include selecting a version that delivered highest average rewards during the test period as the determined version, in some embodiments.

The method 200 may further include, at block 212, receiving from a second user, after the test period, a request for the electronic user interface. The second user may be different from all of the first users, or may have been one of the first users.

The method 200 may further include, at block 214, causing the determined version that delivered highest rewards during the test period to be delivered to the second user. Delivery of the determined version may be performed in a manner similar to delivery of versions during the test period, as described above.

The approach described in the method 200 may improve upon known approaches, as described below.

Test Results—Simulation Setup. Extensive testing was performed to compare info-greedy MAB and info-reward-greedy MAB to various known test approaches. First, fixed-horizon testing was performed. In a fixed-horizon test comparison, all the tests end when their samples reach the same pre-specified sample size NAB or NMAB, which is decided by the typical A/B test requirements based on type I error α, type II error β, minimal detectable effect d, and equation 7 above. The performance between tests using the MAB algorithms and A/B testing can then be compared in terms of the power of the test results, their accuracy of identifying the best version with statistical and practical significance, and overall rewards at the end of the test period (e.g., cumulative rewards obtained during the test period). A simulation dataset was generated with uniformly random versions following a variety set of distributions, in order to test how the algorithms perform under different distribution differences. An industrial dataset was randomly selected from historical A/B tests where the traffic was uniformly randomly distributed.

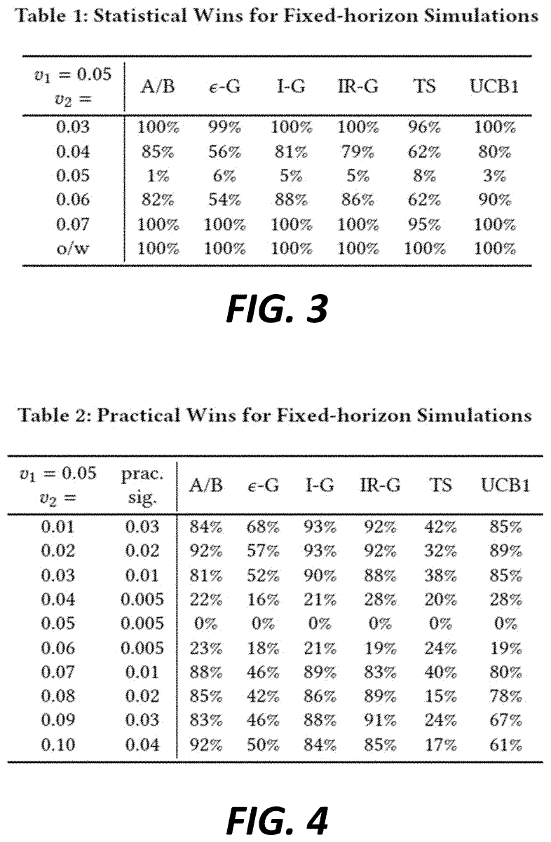

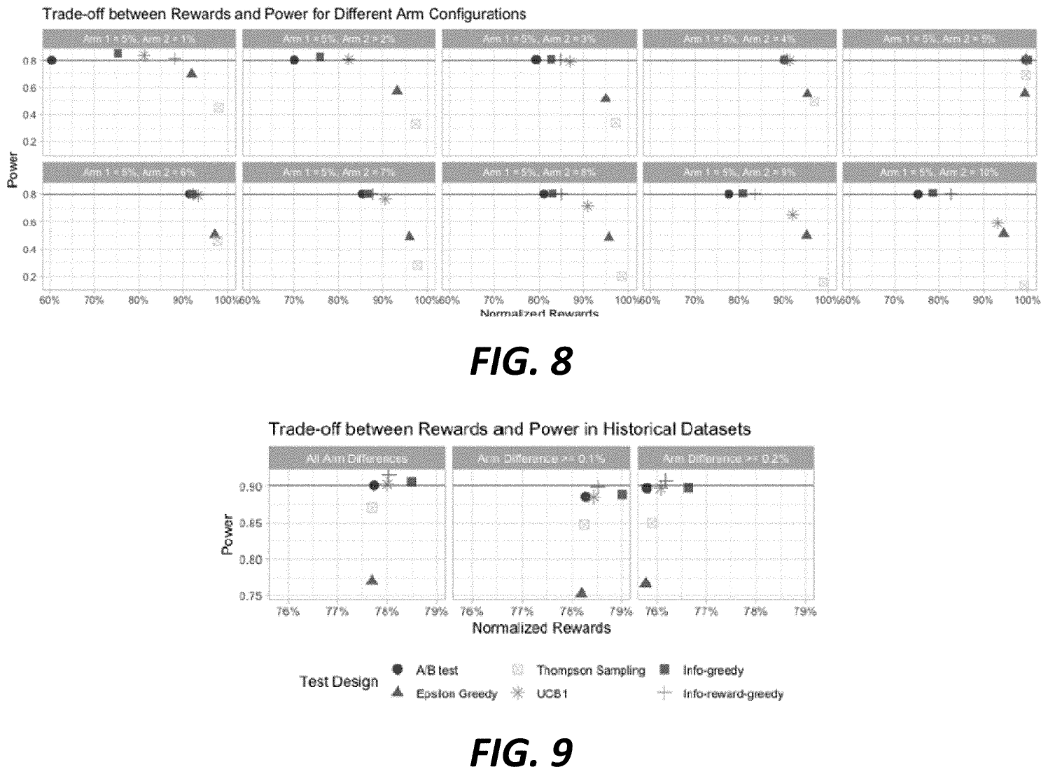

Test Results—Simulation Performance. 6000 trials were performed under the following experimental settings. The type I error was set to 5%, MDE was 0.01, the ground truth mean of Arm 1 (i.e., version 1) is 5%, and the ground truth mean of Arm 2 (i.e., version 2) ranges from 1% to 10%. For each case, 100 rounds of offline evaluations were conducted. As demonstrated in FIGS. 8 and 9, when the two arms have different distributions, Thompson Sampling (TS) achieves the highest total reward whereas the lowest power especially when the difference is large, due to the more aggressive traffic split. Info-greedy (I-G) and Info-reward-greedy (IR-G), on the other hand, achieve relatively high powers and larger rewards compared with the A/B test. Info-greedy (I-G) and Info-reward-greedy (IR-G) also outperformed ∈-Greedy (∈-G) and UCB1 in terms of power without much loss in reward. FIGS. 3 and 4 illustrate the accuracy of each algorithms to detect a fixed winner, i.e. the percentage of trials that achieved statistical or practical significance. Info-greedy and Info-reward-greedy achieve higher accuracy in identifying the practical winners in general.

Performance on Industrial Data Set. Approximately 4000 trials were performed using about 40 different industrial data sets (in which the experiences delivered to the users, and the users' responsive actions, are known), the average power and the average normalized rewards for each algorithm are shown in FIG. 9. Due to the distributions of the variety of the datasets, FIG. 9 illustrates groupings based on the “true” average reward difference. Info-greedy MAB and info-reward-greedy MAB both achieve higher normalized rewards and power in all cases. UCB1 performs relatively better than A/B testing. ∈-greedy shows the lowest power and rewards. Thompson sampling achieve similar rewards as A/B testing in the first two scenarios but higher rewards in the 3rd scenario as the true difference becomes large. However, its power is always lower than A/B testing, UCB1 and the two proposed algorithms. The probabilities to identify statistical and practical significance are almost the same and close to 0.

Dynamic-horizon Test Comparison. Based on the testing described above, some MAB algorithms can achieve a higher power than or equal power to A/B test given a fixed sample size and other test parameters. In reverse, this implies that to achieve a fixed test power, these MAB algorithms can use less or equal sample size relative to an A/B test. For further testing, the power was set at 1−β and the test lengths are flexible, which end at the time they achieve the same test power under given parameters α and d. The performance between the tests using MAB algorithms and A/B testing can then be compared in terms of the total number of samples used (i.e., the speed to achieve the same test power), and their accuracy of identifying the true winner with significance. Before describing the test results, an analysis of how to define power for the tests using MAB algorithms is provided below, to ensure fairness for the comparisons with A/B test.

Early Stopping Criterion. A difficulty for designing flexible-length tests using MAB algorithms is that even if type I error α, type II error β (or power 1−β), and minimum detectable effect d are defined, it cannot be decided in advance how many samples will be needed to achieve the requirements for a typical A/B test. This is because the final sample ratio between two groups, i.e., λ=n₁, n₂ controlled by MAB algorithms normally depend on the algorithm interactions with users' actions (e.g., rewards of those actions), where λ is usually unknown beforehand, unlike the situation of A/B testing where λ is very close to 1.

As noted above in equations 5 and 6, without knowing λ, the total sample size N needed to achieve the power and the other requirements cannot be calculated. Also without knowing N the test stopping time cannot be determined. To overcome this difficulty, the “power” of the MAB tests may be adaptively updated given the other parameter requirements (α and d). It should be noted that this approach is different from a so-called “posthoc power analysis.” In the post-hoc power analysis, the unstandardized effect size d will be replaced by the sample mean difference as the test goes, however in the instant approach, throughout the process the unstandardized effect size is unchanged (i.e., a fixed MDE) and the number of samples for each experience, i.e., Ntn (1) and Ntn (2), is updated, and the variance is given by the sample variances of each experience set forth in equation 9 below:

$${S}_{{t}_{n}}^{2} ( e ) = \frac{{{\sum }_{t = 1}^{n} [ {r}_{{t}_{i}} - {p}_{{t}_{n}} ( e ) ]}^{2} ( {e}_{{t}_{i}} = e )}{{N}_{{t}_{n}} ( e ) - 1} , e ∈ \{ 1 , 2 \} \qquad ( Eq . 9 )$$

for which an unbiased estimator of the true variance for group e can be proved. A variety of numerical experiments a provided below to test this design. For the comparison fairness MAB algorithms and A/B test, all competing tests use the same updating rules for checking whether the “original” power meets the requirements.

Determining an early stopping point can be performed according to algorithm 3 below:

Algorithm 3:
Aggressive Early Stopping (|E| = 2)

| Parameters : α, β, d, S (as described in algorithm 5), T ∈ (0, ∞) | |
|---|---|
| Initialization : H₀ = {an empty logging); ρ = 0; n = 0 | |
| while (ρ < 1 − β) and (tₙ₊₁ < T) do | |
| \| | 1. eₜ_{ₙ₊₁} = an experience generated by strategy S given Hₙ |
| \| | 2. Observe rₜ_{ₙ₊₁}; Hₙ₊₁ = concatenate (Hₙ, (eₜ_{ₙ₊₁}, rₜ_{ₙ₊₁})) |
| \| | $3. ρ \to Φ ( \frac{\vert d \vert}{\sqrt{\frac{{s}_{{t}_{n}}^{2} ( 1 )}{max \{ 1 , {N}_{{t}_{n}} ( 1 ) \}} + \frac{{s}_{{t}_{n}}^{2} ( 2 )}{max \{ 1 , {N}_{{t}_{n}} ( 2 ) \}}}} - {z}_{α / 2} )$ |
| \| | 4. n → n + 1 |

end

Info-greedy MAB and info-reward-greedy MAB approaches were compared to several known test types, in addition to A/B testing, as described above. These additional tests are set forth in algorithms 4, 5, 6, and 7 below.

```
Algorithm 4: ϵ-greedy [15]
Parameters : ϵ > 0, T ϵ (0, + ∞]
Initialization : pₜ_{₀}(e) = 0, ∀e ϵ E;
            H₀ = {an empty logging}; n = 0
while t_{n + 1} < T do
  | 1. σ → Generate a uniform random number ϵ [0, 1]
  | if σ < ϵ then eₜ_{_{n + 1}} = a random selected e ϵ E;
  | eₜ_{_{n + 1}} = argmax_{eϵE}pₜ_{ₙ}(e), with random tie breaking
  | 2. Observe rₜ_{_{n + 1}}; H_{n + 1} = concatenate (Hₙ, (eₜ_{_{n + 1}}, rₜ_{_{n + 1}}))
  | 3. n → n + 1
end
```

Algorithm 5:
Thompson Sampling [12]

| Parameters : (dynamic) αₑ, βₑ, ∀e ∈ E | |
|---|---|
| Initialization : αₑ > 1, βₑ > 1, ∀e ∈ E (to avoid trivial cases); | |
| H₀ = {an empty logging}; n = 0 | |
| while tₙ₊₁ < T do | |
| \| | 1. ∀e ∈ E, \hat{p}ₑ → Generate a sample from Beta |
| \| | distribution B(αₑ, βₑ > 1) |
| \| | $2. {e}_{{t}_{n + 1}} = {argmax}_{e ∈ E} {\hat{p}}_{e} , with random tie breaking$ |
| \| | 2. Observe rₜ_{ₙ₊₁}; Hₙ₊₁ = concatenate (Hₙ, (eₜ_{ₙ₊₁}, rₜ_{ₙ₊₁})) |
| \| | $3. ( {α}_{{e}_{{t}_{n + 1}}} , {β}_{{e}_{{t}_{n + 1}}} ) \to ( {α}_{{e}_{{t}_{n + 1}}} + {r}_{{t}_{n + 1}} , {β}_{{e}_{{t}_{n + 1}}} - {r}_{{t}_{n + 1}} + 1 )$ |
| \| | 4. n → n + 1 |

end

Algorithm 6:
Upper Confidence Bound 1 (UCB1) [2]

| Initialization: pₜ_{₀} (e) = 0, ∀e ∈ E; H₀ = {an empty logging}; n = 0 | |
|---|---|
| while tₙ₊₁ < T do | |
| \| | $\begin{matrix}1. {e}_{{t}_{n + 1}} = {argmax}_{e ∈ E} {p}_{{t}_{n}} ( e ) + \sqrt{\frac{2 ln ( n + \vert E \vert )}{{N}_{{t}_{n}} ( e ) + 1}} , ( Adding \vert E \vert \\ and 1 here to avoid trivial cases , ln ( 0 ) and 0 division . )\end{matrix}$ |
| \| | 2. Observe rₜ_{ₙ₊₁}; Hₙ₊₁ = concatenate (Hₙ, (eₜ_{ₙ₊₁}, rₜ_{ₙ₊₁})) |
| \| | 3. n → n + 1 |

end

```
Algorithm 7: A/B Test Sampling
Parameters: α (type I error), β (type II error), d (MDE,
            substantive or practical significance),
            N (total samples needed, decided by α, β, d),
            T ϵ (0, ∞)
  Initialization: H₀ = {an empty logging}; n = 0
  while (n + 1 < N) and (ₜ_{_{n + 1}} < T) do
  | 1. eₜ_{_{n + 1}} = a uniformly random selected e ϵ E
  | 2. Observe rₜ_{_{n + 1}}; H_{n + 1} = concatenate (Hₙ, (eₜ_{_{n + 1}}, rₜ_{_{n + 1}}))
  | 3. n → n + 1
end
```

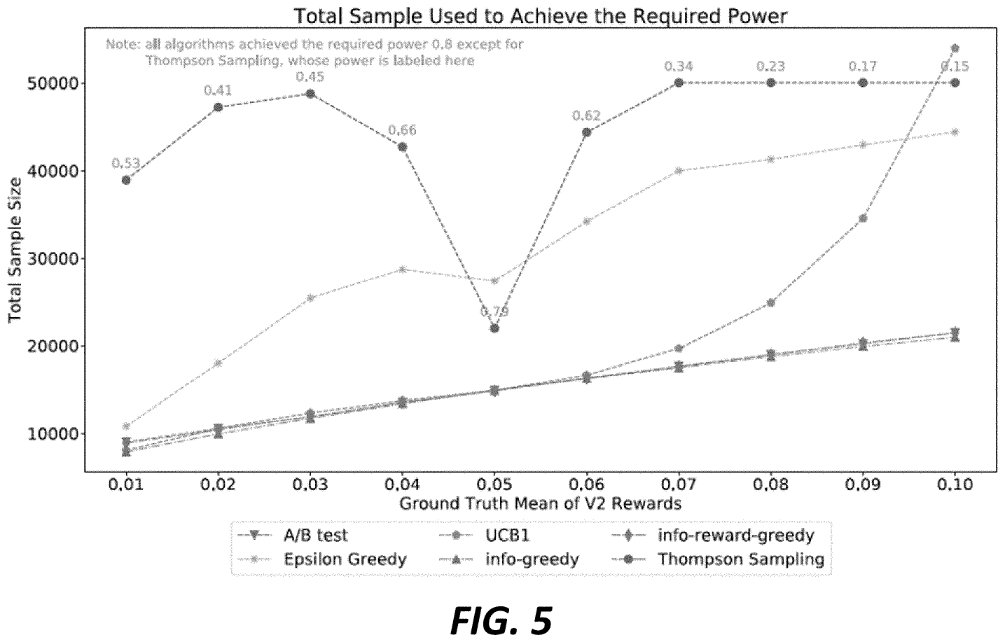

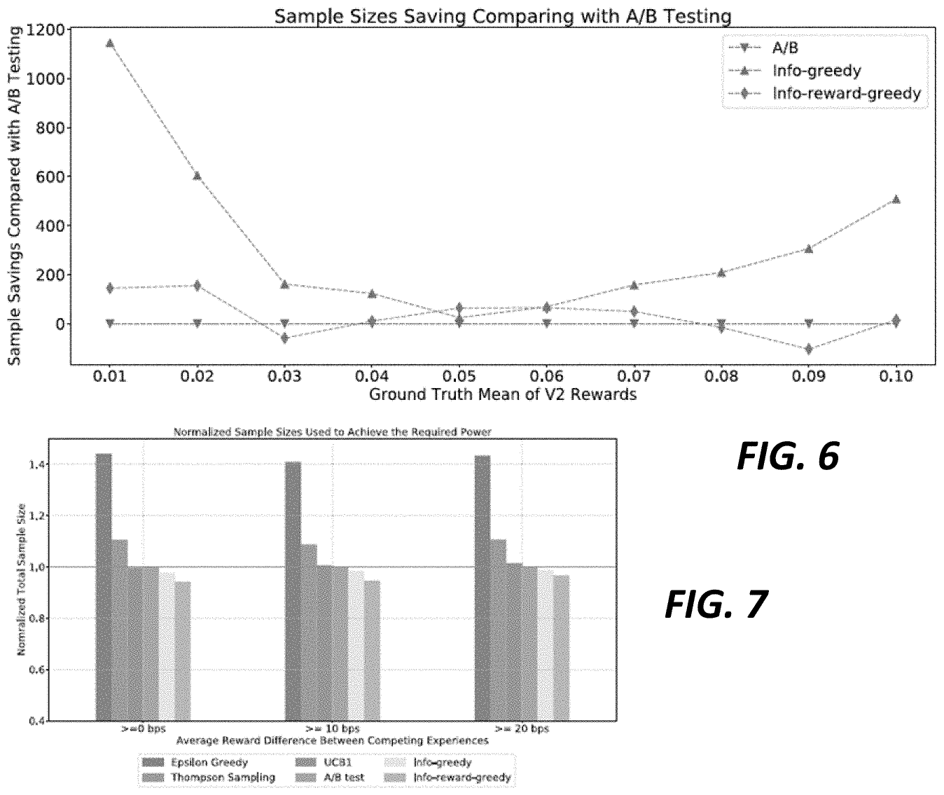

Simulation Performance. With the same parameter settings as in the fixed-horizon simulations above, FIG. 5 shows the sample size used to achieve the required power as the ground truth success rate of V2 changes. Given sufficient population size, all the algorithms reached the desired power except Thompson Sampling. Info-greedy MAB and info-reward greedy MAB require similar or slightly fewer samples compared with A/B test and the sample size grows linearly as the success rate increases. A zoomed-in view presented in FIG. 6 further demonstrates that info-greedy MAB saves more samples when the distribution difference of V1 and V2 is large. UCB1 requires a similar sample size as A/B testing when the success rate is relatively small, however, it grows exponentially when the rate is larger due to more aggressive traffic split. Epsilon Greedy requires more samples but shows advantage over UCB1 when the V2 success rate is large (i.e. 0.01). The accuracy of each algorithms to detect practical wins is similar except Thompson Sampling, which did not reach the desired test power.

Industrial Data Performance. For industrial data tests, the results—normalized sample sizes used to achieve the required power (0.9 here)—are shown in FIG. 5. Similarly, the test scenarios are grouped into three categories based on their “true” average reward difference between competing experiences: no less than 0 basis point (BPS), 10 BPS, and 20 BPS, respectively. The total sample size used by A/B testing was normalized to 1 as a general benchmark. As is clear from FIG. 5, both ∈-greedy and Thompson Sampling algorithms require more samples to achieve the required power than A/B testing and this disclosure's novel approaches. UCB1 is relatively close to A/B testing. The proposed Info-greedy and Info-reward greedy algorithms use fewer samples than A/B testing. In addition, the probabilities to identify statistical and practical significance are almost the same and close to 0. As shown in FIG. 7, the info-greedy MAB approach and the info-reward-greedy MAB approach can both achieve the same test power faster than the other algorithms (including A/B test, Epsilon-greedy, Thompson Sampling, and UCB1), making it possible to stop test earlier, so information greedy MAB algorithms can shorten the testing period without power loss.

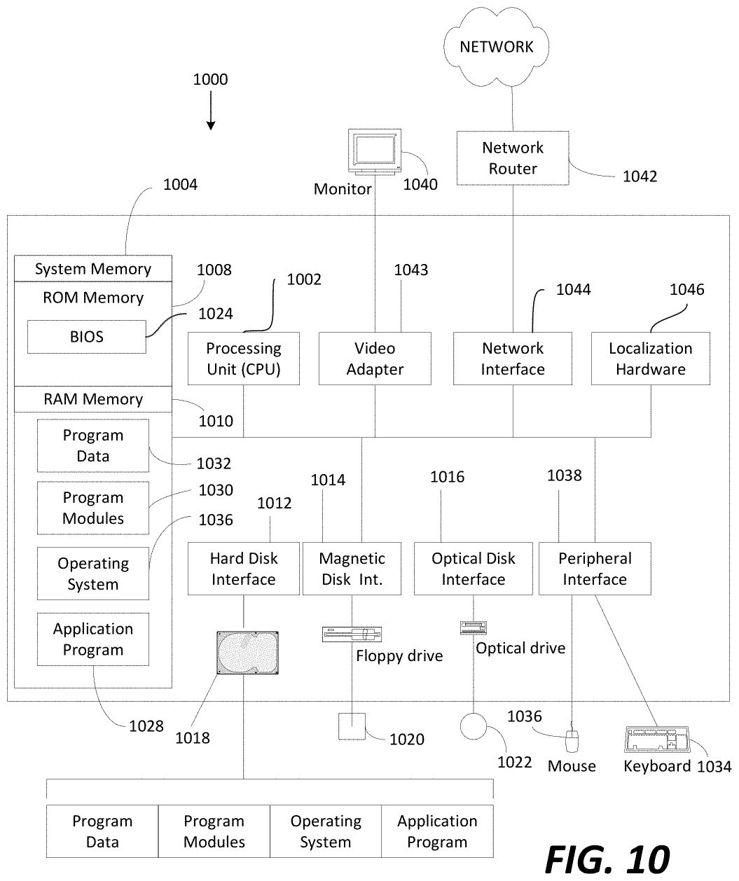

FIG. 10 is a diagrammatic view of an example embodiment of a user computing environment that includes a computing system environment 1000, such as a desktop computer, laptop, smartphone, tablet, or any other such device having the ability to execute instructions, such as those stored within a non-transient, computer-readable medium. Furthermore, while described and illustrated in the context of a single computing system, those skilled in the art will also appreciate that the various tasks described hereinafter may be practiced in a distributed environment having multiple computing systems linked via a local or wide-area network in which the executable instructions may be associated with and/or executed by one or more of multiple computing systems.

In its most basic configuration, computing system environment 1000 typically includes at least one processing unit 1002 and at least one memory 1004, which may be linked via a bus. Depending on the exact configuration and type of computing system environment, memory 1004 may be volatile (such as RAM 1010), non-volatile (such as ROM 1008, flash memory, etc.) or some combination of the two. Computing system environment 1000 may have additional features and/or functionality. For example, computing system environment 1000 may also include additional storage (removable and/or non-removable) including, but not limited to, magnetic or optical disks, tape drives and/or flash drives. Such additional memory devices may be made accessible to the computing system environment 1000 by means of, for example, a hard disk drive interface 1012, a magnetic disk drive interface 1014, and/or an optical disk drive interface 1016. As will be understood, these devices, which would be linked to the system bus, respectively, allow for reading from and writing to a hard disk 1018, reading from or writing to a removable magnetic disk 1020, and/or for reading from or writing to a removable optical disk 1022, such as a CD/DVD ROM or other optical media. The drive interfaces and their associated computer-readable media allow for the nonvolatile storage of computer readable instructions, data structures, program modules and other data for the computing system environment 1000. Those skilled in the art will further appreciate that other types of computer readable media that can store data may be used for this same purpose. Examples of such media devices include, but are not limited to, magnetic cassettes, flash memory cards, digital videodisks, Bernoulli cartridges, random access memories, nano-drives, memory sticks, other read/write and/or read-only memories and/or any other method or technology for storage of information such as computer readable instructions, data structures, program modules or other data. Any such computer storage media may be part of computing system environment 1000.

A number of program modules may be stored in one or more of the memory/media devices. For example, a basic input/output system (BIOS) 1024, containing the basic routines that help to transfer information between elements within the computing system environment 1000, such as during start-up, may be stored in ROM 1008. Similarly, RAM 1010, hard disk 1018, and/or peripheral memory devices may be used to store computer executable instructions comprising an operating system 1026, one or more applications programs 1028 (which may include the functionality of the experience testing system 102 of FIG. 1, for example), other program modules 1030, and/or program data 1032. Still further, computer-executable instructions may be downloaded to the computing environment 1000 as needed, for example, via a network connection.

An end-user may enter commands and information into the computing system environment 1000 through input devices such as a keyboard 1034 and/or a pointing device 1036. While not illustrated, other input devices may include a microphone, a joystick, a game pad, a scanner, etc. These and other input devices would typically be connected to the processing unit 1002 by means of a peripheral interface 1038 which, in turn, would be coupled to bus. Input devices may be directly or indirectly connected to processor 1002 via interfaces such as, for example, a parallel port, game port, firewire, or a universal serial bus (USB). To view information from the computing system environment 1000, a monitor 1040 or other type of display device may also be connected to bus via an interface, such as via video adapter 1043. In addition to the monitor 1040, the computing system environment 1000 may also include other peripheral output devices, not shown, such as speakers and printers.

The computing system environment 1000 may also utilize logical connections to one or more computing system environments. Communications between the computing system environment 1000 and the remote computing system environment may be exchanged via a further processing device, such a network router 1042, that is responsible for network routing. Communications with the network router 1042 may be performed via a network interface component 1044. Thus, within such a networked environment, e.g., the Internet, World Wide Web, LAN, or other like type of wired or wireless network, it will be appreciated that program modules depicted relative to the computing system environment 1000, or portions thereof, may be stored in the memory storage device(s) of the computing system environment 1000.

The computing system environment 1000 may also include localization hardware 1046 for determining a location of the computing system environment 1000. In embodiments, the localization hardware 1046 may include, for example only, a GPS antenna, an RFID chip or reader, a WiFi antenna, or other computing hardware that may be used to capture or transmit signals that may be used to determine the location of the computing system environment 1000.

The computing environment 1000, or portions thereof, may comprise one or more components of the system 100 of FIG. 1, in embodiments.

While this disclosure has described certain embodiments, it will be understood that the claims are not intended to be limited to these embodiments except as explicitly recited in the claims. On the contrary, the instant disclosure is intended to cover alternatives, modifications and equivalents, which may be included within the spirit and scope of the disclosure. Furthermore, in the detailed description of the present disclosure, numerous specific details are set forth in order to provide a thorough understanding of the disclosed embodiments. However, it will be obvious to one of ordinary skill in the art that systems and methods consistent with this disclosure may be practiced without these specific details. In other instances, well known methods, procedures, components, and circuits have not been described in detail as not to unnecessarily obscure various aspects of the present disclosure.

Some portions of the detailed descriptions of this disclosure have been presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic data capable of being stored, transferred, combined, compared, and otherwise manipulated in a computer system or similar electronic computing device. For reasons of convenience, and with reference to common usage, such data is referred to as bits, values, elements, symbols, characters, terms, numbers, or the like, with reference to various embodiments of the present invention.

It should be borne in mind, however, that these terms are to be interpreted as referencing physical manipulations and quantities and are merely convenient labels that should be interpreted further in view of terms commonly used in the art. Unless specifically stated otherwise, as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers, or other such information storage, transmission, or display devices as described herein or otherwise understood to one of ordinary skill in the art.

What is claimed is:

1. A method for determining a user experience for an electronic user interface, the method comprising:
defining a test period for testing two or more versions of an electronic user interface;
receiving, from each of a plurality of users during the test period, a respective request for the electronic user interface;
determining, for each of the plurality of users, a respective version of the two or more versions of the electronic user interface by maximizing test power during the test period while maintaining higher in-test rewards than an A/B test; and
causing, for each of the plurality of users, the determined version of the electronic user interface to be delivered to the user.

2. The method of claim 1, wherein the two or more versions comprises two versions, wherein maximizing test power during the test period while maintaining higher in-test rewards than an A/B test comprises:
calculating a first ratio of a total number of times each of the two versions has been provided to users;
calculating a square root of a second ratio of cumulative rewards of the two versions, where the cumulative rewards for each version are calculated as a product of the cumulative reward of the version and one-minus the cumulative reward of the version; and
comparing the first ratio to the square root of the second ratio.

3. The method of claim 2, wherein the reward is a Boolean value.

4. The method of claim 3, wherein the reward for a user indicates whether the user performed a predefined action in the electronic user interface.

5. The method of claim 2, wherein the reward is a continuous value between zero and one.

6. The method of claim 5, wherein the reward indicates a value from a continuous range of values of an interaction of the user with the electronic user interface.

7. The method of claim 1, wherein the electronic user interface is a portion of a webpage.

8. The method of claim 7, wherein the portion of the webpage comprises a home page of a website.

9. The method of claim 1, wherein the users are first users, the method further comprising:
determining one of the two or more versions that delivered highest rewards during the test period;
after the test period, receiving a request from a second user for the electronic user interface; and
causing the determined version that delivered highest rewards during the test period to be delivered to the second user.

10. A method for determining a user experience for an electronic user interface, the method comprising:
defining a test period for testing two or more versions of an electronic user interface;
receiving, from each of a plurality of users during the test period, a respective request for the electronic user interface;
determining, for each of the plurality of users, a respective version of the two or more versions of the electronic user interface by maximizing rewards during the test period while maintaining a test power no worse than an A/B test; and
causing, for each of the plurality of users, the determined version of the electronic user interface to be delivered to the user.

11. The method of claim 10, wherein the two or more versions comprises two versions, wherein maximize the rewards during the test period while maintaining a test power no worse than an A/B test comprises:
calculating a first ratio of a total number of times each version has been provided to users;
calculating a second ratio of cumulative rewards for the two versions, where the cumulative rewards for each version are calculated as a product of the cumulative reward of the experience and one-minus that reward; and
comparing the first ratio to the second ratio.

12. The method of claim 11, wherein the reward is a Boolean value.

13. The method of claim 12, wherein the reward for a user indicates whether the user performed a predefined action in the electronic user interface.

14. The method of claim 11, wherein the reward is a continuous value between zero and one.

15. The method of claim 14, wherein the reward indicates a value from a continuous range of values of an interaction of the user with the electronic user interface.

16. The method of claim 10, wherein the electronic user interface is a portion of a webpage.

17. The method of claim 16, wherein the portion of the webpage comprises a home page of a website.

18. The method of claim 10, wherein the users are first users, the method further comprising:
determining one of the two or more versions that delivered highest rewards during the test period;
after the test period, receiving a request from a second user for the electronic user interface; and
causing the determined version that delivered highest rewards during the test period to be delivered to the second user.

19. A method for determining a user experience for an electronic user interface, the method comprising:
defining a test period for testing two or more versions of an electronic user interface;
receiving, from each of a plurality of users during the test period, a respective request for the electronic user interface;
determining, for each of the plurality of users, a respective version of the two or more versions of the electronic user interface by:
maximizing test power during the test period while maintaining higher in-test rewards than an A/B test; or
maximizing the rewards during the test period while maintaining a test power no worse than an A/B test; and
causing, for each of the plurality of users, the determined version of the electronic user interface to be delivered to the user.

20. The method of claim 19, wherein the two or more versions comprises two versions, wherein:
maximizing the rewards during the test period while maintaining a test power no worse than an A/B test comprises:
calculating a first ratio of a total number of times each version has been provided to users;
calculating a second ratio of cumulative rewards for the two versions, where the cumulative rewards for each version are calculated as a product of the cumulative reward of the experience and one-minus that reward; and
comparing the first ratio to the second ratio; and
maximizing test power during the test period while maintaining higher in-test rewards than an A/B test comprises:
calculating a first ratio of the total number of times each of the two versions has been provided to users;
calculating a square root of a second ratio of cumulative rewards of the two versions, where the cumulative rewards for each version are calculated as a product of the cumulative reward of the version and one-minus the cumulative reward of the version; and
comparing the first ratio to the square root of the second ratio.
